(19) United States
(12) Patent Application Publication
(10) Pub. No.: US 2014/0365955 A1
(43) Pub. Date: Dec. 11, 2014

(54) WINDOW RESHAPING BY SELECTIVE EDGE REVISIONS

(71) Applicant: International Business Machines Corporation, Armonk, NY (US)

(72) Inventors: Lisa Seacat DeLuca, Baltimore, MD (US); Lydia M. Do, Raleigh, NC (US); Charles M. Kinard, Cary, NC (US)

(21) Appl. No.: 13/913,568

(22) Filed: Jun. 10, 2013

(51) Int. Cl. G06F 3/0484

(52) U.S. Cl. CPC G06F 3/0484
USPC 715/788

(57) ABSTRACT

Aspects revise the shape of a window displayed in a graphical user interface environment by removing one or more selected boundary edge lines of the window as displayed within a graphical user interface environment in an initial appearance shape and including display content. The definitions of one or more new replacement boundary elements are received, and the initial appearance shape of the window is revised into a revised appearance shape that is defined by the replacement boundary element(s) and one or more remainder boundary edge lines that are not removed. Display of the display content of the window is initiated within the revised appearance shape of the first window.

### FIELD OF THE INVENTION

The present invention relates to the management of the display of content within multiple windows in a graphical user interface display environment.

### BACKGROUND

Z-order methods and techniques provide for an ordering of overlapping two-dimensional objects within a display environment, such as each of multiple windows in a graphical user interface (GUI) desktop display or other display environment, shapes in a vector graphics editor, or objects in a three-dimensional (3D) application. The term “Z-order” refers to the order of objects along the Z-axis. In coordinate geometry, X typically refers to the horizontal axis (left to right), Y to the vertical axis (up and down), and Z refers to the axis perpendicular to the other two (forward or backward). Z-order terminology refers to windows in a GUI as a series of planes parallel to the surface of the display (monitor, device screen, etc.). The windows are therefore stacked along the Z-axis, and the Z-order information thus specifies the front-to-back ordering of the windows on the screen. An analogy would be some sheets of paper scattered on top of a table, each sheet being a window, the table your computer screen, and the top sheet having the highest Z value.

In a GUI desktop display a plurality of windows may be open, each representing a different application or task that a user has opened. Typically, users of a GUI affect the Z-order by selecting a window to be brought to the foreground (that is, “above” or “in front of” all the other windows). Some window managers allow interaction with windows while they are not in the foreground, while others will bring a window to the front whenever it receives input from the user. It is also possible for special windows to be designated “always on top”; these are then fixed to the top of the Z-order so that (with few exceptions) no other window can overlap them.

Although the windows may be operating in parallel, if the windows overlap then their Z-order determines which one appears on top of the other, with the one having the highest Z-order value displayed on top of and hiding some or all of the remaining others of the windows. In order to see the hidden display of any of the other windows, that window is selected by a GUI routine, which causes the newly-selected window to be considered the active window and moved to the front of all of the other windows via a revised Z-ordering, wherein the active window is awarded the highest Z-order value of all of the other windows.

### BRIEF SUMMARY

In one aspect of the present invention, a method for revising the shape of a window displayed in a graphical user interface environment includes receiving a selection of one or more boundary edge lines of a first window displayed within a graphical user interface environment in an initial appearance shape and including display content. The selected boundary edge line(s) are removed, and one or more new replacement boundary elements are defined. The initial appearance shape of the first window is revised into a revised appearance shape that is defined by the replacement boundary element(s) and one or more remainder boundary edge line that are not removed. Display of the content of the first window is initiated within the revised appearance shape of the first window.

In another aspect, a system has a processing unit, computer readable memory and a tangible computer-readable storage medium with program instructions, wherein the processing unit, when executing the stored program instructions, receives a selection of one or more boundary edge lines of a first window displayed within a graphical user interface environment in an initial appearance shape and including display content. The selected boundary edge line(s) are removed, and one or more new replacement boundary elements are defined. The initial appearance shape of the first window is revised into a revised appearance shape that is defined by the replacement boundary element(s) and one or more remainder boundary edge lines that are not removed. Display of the content of the first window is initiated within the revised appearance shape of the first window.

In another aspect, a computer program product for revising the shape of a window displayed in a graphical user interface environment has a tangible computer-readable storage medium with computer readable program code embodied therewith. The computer readable program code includes instructions that, when executed by a computer processing unit, cause the computer processing unit to receive a selection of one or more boundary edge lines of a first window displayed within a graphical user interface environment in an initial appearance shape and including display content. The selected boundary edge line(s) are removed, and one or more new replacement boundary elements are defined. The initial appearance shape of the first window is revised into a revised appearance shape that is defined by the replacement boundary element(s) and one or more remainder boundary edge lines that are not removed. Display of the content of the first window is initiated within the revised appearance shape of the first window.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method, system or process according to the present invention for revising the shape of a window displayed in a GUI environment.

FIG. 2 is a graphical illustration of a graphical user interface environment display according to an aspect of the present invention.

FIG. 3 is a graphical illustration of another graphical user interface environment display according to an aspect of the present invention.

FIG. 4 is a graphical illustration of another graphical user interface environment display according to an aspect of the present invention.

FIG. 5 is a graphical illustration of another graphical user interface environment display according to an aspect of the present invention.

FIG. 6 is a graphical illustration of another graphical user interface environment display according to an aspect of the present invention.

FIG. 7 is a graphical illustration of another graphical user interface environment display according to an aspect of the present invention.

FIG. 8 is a graphical illustration of another graphical user interface environment display according to an aspect of the present invention.

FIG. 9 is a graphical illustration of another graphical user interface environment display according to an aspect of the present invention.

FIG. 10 is a block diagram illustration of a computer system implementation of an aspect of the present invention.

The drawings are not necessarily to scale. The drawings are merely schematic representations, not intended to portray specific parameters of the invention. The drawings are intended to depict only typical aspects, examples and embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

Displaying multiple windows in a GUI environment presents a number of challenges. In order to avoid window overlap conflicts that cause overlapping content to be hidden by a top, active window via Z-ordering techniques, users generally move or resize windows so that they occupy unique, non-overlapping positions within the screen, for example next to each on a screen. However, this approach is not helpful when large numbers of windows are open. Resizing windows to reduce their overall footprint in order to share available display space in a desktop environment with other windows and avoid overlaps may proportionately reduce the scale or size of window content. Reductions in type font size may reduce the legibility of content to an unsatisfactory degree, sometimes rendering text illegible or losing visual information when image data is zoomed in or granularity is lost.

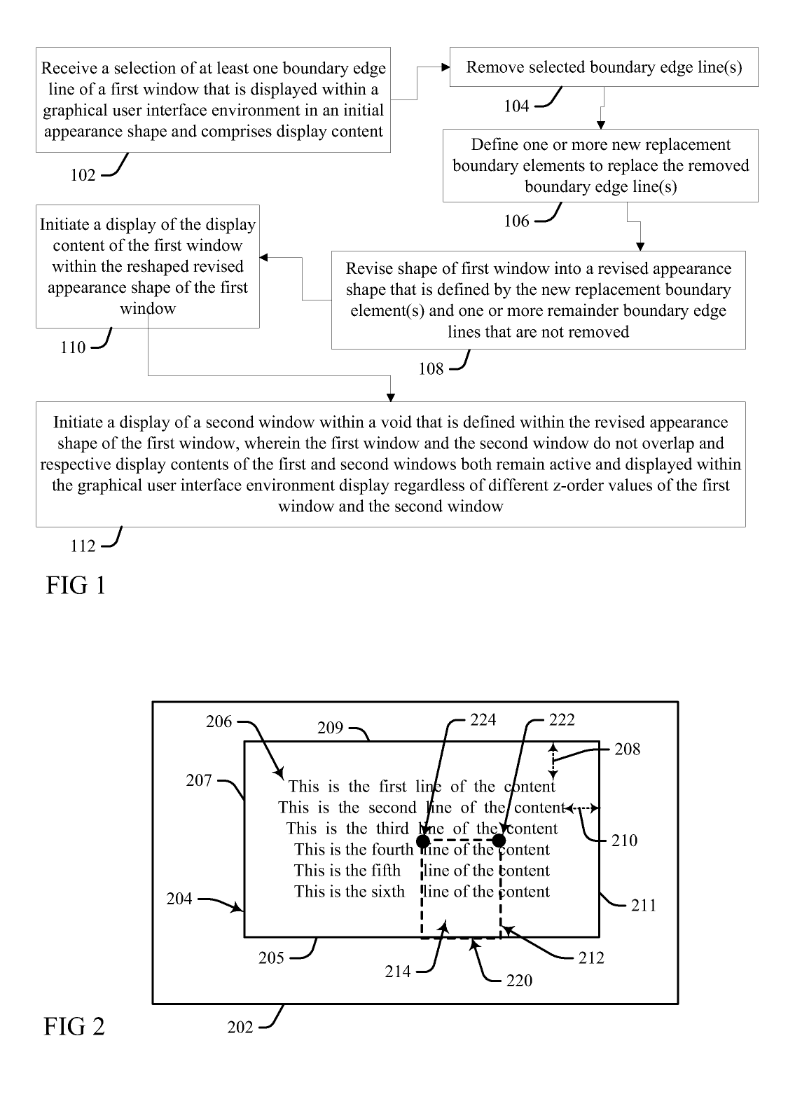

FIG. 1 illustrates a method, system or process according to the present invention for revising the shape of a window displayed in a GUI environment. At 102 a selection is received of one or more boundary edge lines of a first window that is displayed within a graphical user interface environment in an initial appearance shape and comprises display content. In some aspects the selection is by a user, for example, via a cursor, a pen or tactile engagement of a multi-touch device display screen, etc. The term “window” will be understood to comprehend any displayed object that can be resized to be less than a full viewing area available within the GUI display. The term “line” will be understood to comprehend line segments, portions, or subsets of longer line elements. The initial appearance of the first window displays text and/or image content to the user in an initial size (font size, image data unit-per-square inch level, zoom-level, etc.) and at content locations defined relative to an outermost boundary edge or set of edges that defines an overall footprint of the window within the GUI display.

The outer boundary edge or edges of the initial view of the first window may define a geometric shape footprint. Examples include a rectangular, quadrilateral shape with four linear edge segments defining four right angles; a circle defined by a continuous curving linear edge defined on a radius or diameter from a center point; an ellipse shape having a variable curving linear edge, such as defined by the locus of a plane of distances to two fixed points adding to the same constant; an oval shape having a variable curving linear edge defined in a projective plane as a function of a set of points, no three collinear, such that there is a unique tangent line at each point, wherein a tangent line is defined as a line meeting the point set at only one point, also known as a one-secant; irregular shapes defined by combinations of rectilinear and curving linear segments, for example as defined combining rectangle, circle, ellipse or oval portions; and still other geometric shapes may be defined by one or more outer boundary lines and curves.

At 104 the selected boundary edge line(s) is/are removed. At 106 one or more new replacement boundary elements are defined to replace the removed boundary edge line(s). At 108 the shape of the first window is revised into a new, revised shape that is defined by the new replacement boundary element(s) and one or more remainder boundary edge lines that are not removed. More particularly, the shape of the first window is changed by locating the new replacement boundary element(s) at a different location or locations relative to positions of the removed boundary elements that were used to define the initial shape of the window, resulting in a revised appearance shape of the first window that has a revised footprint area that is different from an initial footprint of the first window. At 110 a display is initiated of the display content of the first window within the reshaped revised appearance shape of the first window.

Revising the shape of the first window at 108 may include removing a selected portion of the initial appearance of the first window to define a void within the revised appearance shape of the first window. Accordingly, in some aspects at 112 display of a second window within the defined void is initiated, wherein the first window and the second window do not overlap and respective display contents of the first and second windows both remain active and displayed within the graphical user interface environment display regardless of different Z-order values of the first window and the second window.

Initiated displays of the content of the first window within the reshaped window at 110 may omit portions of the content (for example, text items or image content portions, etc.) that were originally displayed in the initial appearance of the first window within a selected, removed portion of the initial appearance of the first window, and redisplay the other, remainder portions of initial view window contents within the reshaped window at their same initial size or scale, and at their same locations defined relative to the initial outer boundary edges of the window in the initial view at 102. In other aspects, the content presented in the initial appearance/view at 102 is rearranged and/or rescaled to fit within the new shape of the window, which may include an entirety of an amount of the content presented in the initial appearance/view at 102.

FIG. 2 illustrates a graphical user interface (GUI) environment display 202 according to an aspect of the process and system of FIG. 1. The GUI environment display 202 includes a first window 204 having a rectangular footprint defined by four outer boundary linear edges 205, 207, 209 and 211. Text content 206 is displayed in the first window 204 in a first font size and within a spatial location relative to the outer window boundaries 205 (or its remainder portions 305 and 307), 207, 209 and 211, for example with respect to a vertical margin dimension 208 relative to the top and bottom window boundaries 205, 209, 305 and 307; and a minimum horizontal center-justified margin dimension 210 relative to either of the left and right window boundaries 207, 211.

A dashed subset rectangular portion 212 of the first window 204 is selected and defined by a user (at 102, FIG. 1) that encompasses some portions 214 of the text content 206. The selection may be made by selecting and erasing a line segment 220 of the bottom boundary line 205, and either or both of corner points 222 and 224 within the window, wherein the dashed rectangular portion 212 is defined by said deletion line segment 220 and corner point or points 222, 224. Still other portion selection shapes and techniques will be apparent to one skilled in the art.

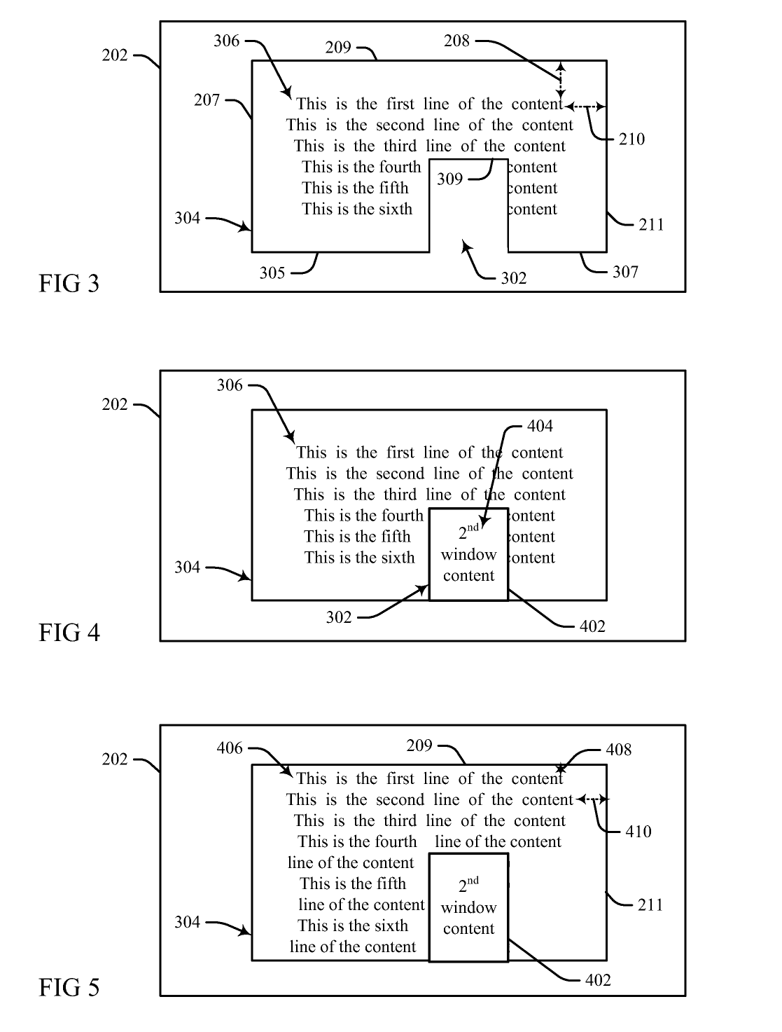

FIG. 3 is a view of the environment display 202 that includes the first window as reshaped 304 after the portion 212 selected by the user has been deleted (at 104-106-108, FIG. 1). More particularly, the first window still fits within the footprint defined by the initial window shape 204, but is revised into an irregular rectilinear window shape 304 defined by the original left edge line 207, top edge line 209 and right edge line 211 of the initial view, and by remaining portion lines 305 and 307 of the initial view bottom edge line 205 and boundaries 309 of a void 302 defined by the rectangular selection portion 212. The text content 206 of the first, original view is revised into an alternative content 306 that is displayed within the reshaped window 304 at the same initial font and positions 208 and 210 relative to the original boundaries 209 and 211 of the first text presentment 206, but which omits (at 110, FIG. 1) the text content portions 214 encompassed by the rectangular selection portion 212.

FIG. 4 shows a second window 402 aligned coextensively with and displayed within the void 302 defined within the new first window shape 304 (at 112, FIG. 1). Thus, regardless of their relative Z-order values, the GUI display 202 depicts the content 206 of the first window 304 and the content 404 of the second window 402. The revised, irregular window shape 304 accommodates the second window 402 within the footprint defined by the initial, original first window rectangular shape 204.

FIG. 5 illustrates an alternative aspect wherein the entirety of the original text content presented in the initial appearance/view 206 (at 102, FIG. 1) is maintained within the first window shape 304 (at 110, FIG. 1) in a new presentment 406. In the present example, the same text font size is maintained, but a new vertical margin 408 that is smaller than the original margin 208, and a new minimum horizontal center-justified margin 410 that is smaller than the original horizontal margin 210, are each used to present the text content via a new word wrapping presentation generated as a function of the new margins 408 and 410. In the present example, said new margins 408 and 410 are sufficient relative to the void 302 to fit all of the text (including the text content portions 214 encompassed by the rectangular selection portion 212) within the new first window shape 304. In other aspects, some of the text content may be lost, for example to another page, or to a portion not within the present view but viewable by using a slider on the side of the window, etc.

Accordingly, aspects of the present invention enable a user to freely redraw windows to remove one or more portions of a displayed window to fit other windows within, so that the content of each window may be continually visible and available to the user independent of their different respective Z-order values. The user may thereby display the content within the altered window at the same size, zoom-level and location relative to an original or preferred view, and avoid having to change content presentments by zooming in or shrinking font sizes.

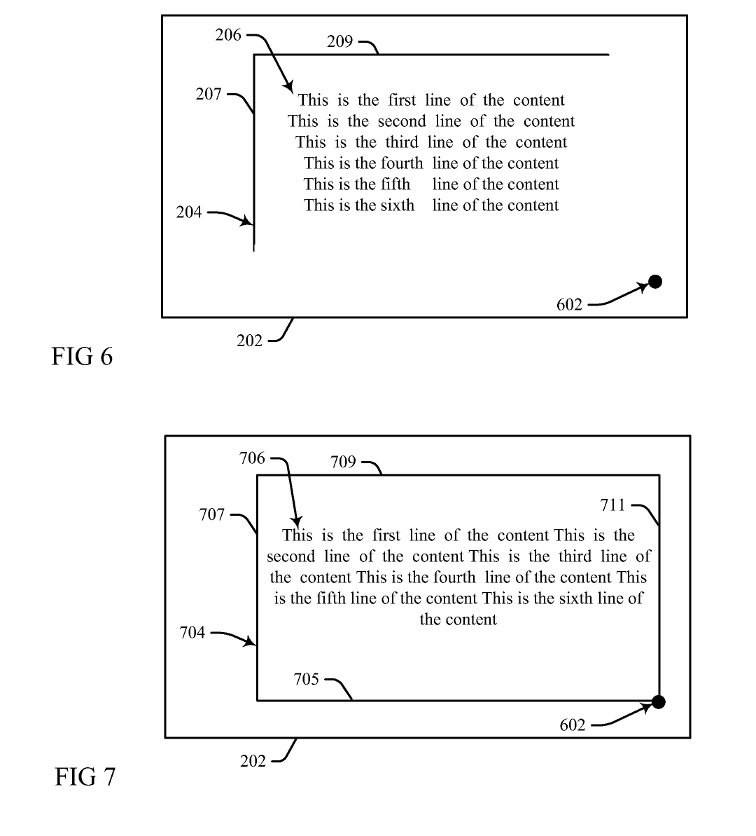

FIG. 6 illustrates another aspect wherein the initial window 204 of FIG. 2 is instead reshaped (at 104-106-108, FIG. 1) by being expanded to meet new boundary lines located outside of the original footprint. More particularly, the bottom and right boundary linear edges 205 and 211 of the first window 204 are erased (for example, via a pen, finger swipe, cursor or other input from the user); while the left edge line 207 and top edge line 209 remain. The defined new replacement boundary elements is a corner dot 602 drawn by a user or otherwise located outside of the initial window footprint presented to the user at 102 that indicates a new position of a corner of a reshaped iteration of the first window.

FIG. 7 illustrates a new, revised shape 704 of the first window as a new, larger rectangular window automatically generated (at 108) as a solution for the remaining (non-removed) boundary lines 207 and 209 and the corner dot 602. Accordingly, the remaining left boundary line 207 is extended into a longer left side boundary line 707 in order to define a corner intersection with a new bottom boundary line 705 that is parallel to the original top line 209/new top line 709 and extends from the left side boundary line 707 to the corner dot 602. The remaining top boundary line 209 is extended into a longer top side boundary line 709 in order to define a corner intersection with a new right boundary line 711 that is parallel to the original left line 207/new left line 707 and extends from the top boundary line 709 to the corner dot 602. The content 706 has the same text as initially presented in 204, but in fewer lines due to new word wrapping in the bigger window rectangle 704.

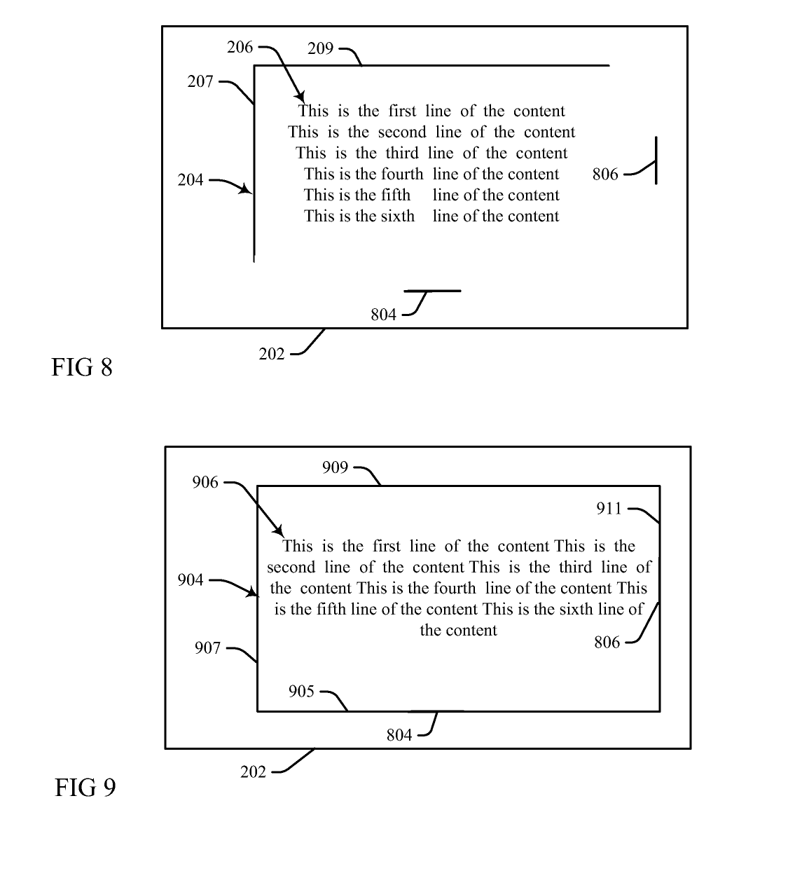

FIG. 8 illustrates another aspect wherein the initial window 204 of FIG. 2 is reshaped (at 104-106-108, FIG. 1) by erasing the bottom and right boundary linear edges 205 and 211 and defining a pair of new replacement boundary element dashes, namely a bottom boundary line location dash 804 and a right side boundary line location dash 806. FIG. 9 illustrates a new, revised shape 904 of the first window as a new, larger rectangular window automatically generated (at 108) as a solution for the remaining (non-removed) boundary lines 207 and 209 and the boundary line location dashes 904 and 906. The remaining left boundary line 207 is extended into a longer left side boundary line 907 in order to define a corner intersection with a new bottom boundary line 905 that is parallel to the original top line 209/new top line 909 and extends from the left side boundary line 907 to the other new right boundary line 911 and incorporates the bottom boundary line location dash 804. The remaining top boundary line 209 is extended into a longer top boundary line 909 in order to define a corner intersection with the new right boundary line 911 that is parallel to the original left line 207/new left line 907 and extends from the top boundary line 909 to the other new bottom boundary line 905 and incorporates the right boundary line location dash 806. The content 906 has the same text as initially presented in 204, but in fewer lines due to new word wrapping in the bigger window rectangle 904.

Aspects may be implemented within Interactive Plasma Display (IPD) environment. IPD generally utilize a pen system for GUI inputs from the user. The pen system allows each of a plurality of pens to be uniquely identified, and thus to be uniquely associated with a given user. They also enable high-speed drawing, simultaneous user drawing and multiple user drawing within high quality (high resolution and granularity) image generation, including via wireless connections to a personal computer (PC) or tablet display. However, pen-based computing systems may experience calibration issues due to mechanical limitations relating to pens, displays, and digitizers. Digitizer hardware may report interaction pen positions (for example, X, Y coordinates) that do not exactly match the location on the display where the visual target is located. This may occur because the display device that generates the visual target is different and independent from the digitizer device used to recognize the location of the pen during input interaction. Other sources of calibration issues may include, for example: electromagnetic noise caused by hard drives and/or power supplies, sensitivity characteristics of the digitizer hardware (for example, the digitizer's sensitivity may change with temperature, elevation, humidity, etc.)

As a result, a user may be physically pointing to and interacting with one location on the display screen via a pen, but actually interacting with an offset location in the system as recognized by the underlying digitizer. Such differences may be problematic during tasks of fine targeting, such as when a user attempts to resize an input window panel by dragging a panel's edge, or to click on a small icon, button, or other object, such as the maximize, restore, or close buttons on an input panel, or the like. Furthermore for multi-touch devices in general, the use of traditional resize methods generally rely on visual feedback from a cursor position at a particular designated point to initiate a resize, which may be difficult to achieve with multi-touch devices.

In contrast, aspects of the present invention enable a user to quickly erase and redraw window borders by clicking anywhere on the edge, without having to exactly align with and trigger a typical Windows® operating system resize arrow by holding down a left mouse button while moving the mouse, etc. (WINDOWS is a trademark of the Microsoft Corporation in the United States or other countries.) Further, IPD and multi-touch devices may not provide such a resize handler, let alone a cursor, which makes it hard for a user to know if they are performing a correct action, and even if provided, putting a pen or finger right on a resize handler element or other specific boundary element is inherently difficult, especially without visual feedback provided by a cursor of where the pen will touch the screen before it actually touches. With a mouse, position and selection are independent actions, but they are unified with respect to a pen or finger input.

Aspects of the present invention obviate the need for a user to draw an entire new area to increase or decrease the size of the window, or to accurately manipulate designated resizing handles and icons. Instead, the user may selectively erase and draw portions of windows and associated boundary elements, for example, providing larger-scale indicators 804, 806 or 602 for the location of new boundaries that may be automatically generated via geographic principals and templates.

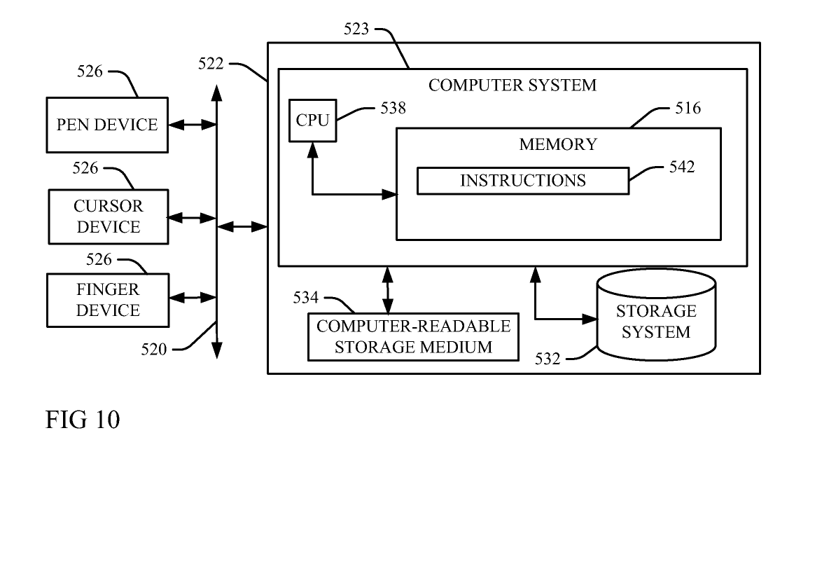

Referring now to FIG. 10, an exemplary computerized implementation of an aspect of the present invention includes a computer system or other programmable device 522 in communication 520 with one or more graphical user interface input devices 526 (for example, pen, cursor and touchpad finger input devices 526) that provide boundary edge line drawing and erasing inputs as described above with respect to FIGS. 1-9. The programmable device 522 thus removes selected boundary edge lines of windows displayed within a graphical user interface environment, defines replacement boundary elements and initiates displays that revise the appearance shape of the windows as a function of the replacement boundary elements, as described above with respect to FIGS. 1 through 9. Instructions 542 reside within computer readable code in a computer readable memory 516, or in a computer readable storage system 532, or other tangible computer readable storage medium 534 that is accessed by a Central Processing Unit (CPU) 538 of a computer system or infrastructure 523 of the mobile device 522. Thus, the instructions, when implemented by the processing unit 538, cause the processing unit 538 to remove selected boundary edge lines of windows displayed within a graphical user interface environment, define replacement boundary elements and revise the appearance shape of the windows as a function of the replacement boundary elements, as described above with respect to FIGS. 1 through 9.

In one aspect, the present invention may also perform process steps of the invention on a subscription, advertising, and/or fee basis. That is, a service provider could offer to integrate computer-readable program code into the computer system 522 to enable the computer system 522 to select and remove boundary edge lines of windows displayed within a graphical user interface environment, define replacement boundary elements and revise the appearance shape of the windows as a function of the replacement boundary elements, as described above with respect to FIGS. 1 through 9. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for revising the shape of a window displayed in a graphical user interface environment, the method comprising
receiving a selection of at least one boundary edge line of a first window that is displayed within a graphical user interface environment in an initial appearance shape and comprises display content;
removing the selected at least one boundary edge line of the first window;
receiving a definition of at least one new replacement boundary element;
revising the initial appearance shape of the first window into a revised appearance shape that is defined by the at least one new replacement boundary element and at least one remainder boundary edge line that is not removed; and
initiating a display of the display content of the first window within the revised appearance shape of the first window.

2. The method of claim 1, wherein the step of removing the at least one boundary edge line comprises erasing the at least one boundary edge line.

3. The method of claim 1, wherein the step of receiving the definition of the at least one new replacement boundary element comprises receiving at least one of a corner dot and a boundary line dash, wherein the received at least one of the corner dot and the boundary line dash indicates a position of at least one new boundary element that is different from a position of the removed selected at least one boundary edge line of the first window, and wherein the revised appearance shape of the first window has a revised footprint area that is different from an initial footprint of the first window.

4. The method of claim 1, further comprising:
integrating computer-readable program code into a computer system comprising a processing unit, a computer readable memory and a computer readable tangible storage medium, wherein the computer readable program code is embodied on the computer readable tangible storage medium and comprises instructions that, when executed by the processing unit via the computer readable memory, cause the processing unit to perform the steps of receiving the selection of the at least one boundary edge line of the first window that is displayed within the graphical user interface environment in the initial appearance shape and comprises the display content, removing the selected at least one boundary edge line of the first window, receiving the definition of the at least one new replacement boundary element, revising the initial appearance shape of the first window into the revised appearance shape that is defined by the at least one new replacement boundary element and the at least one remainder boundary edge line that is not removed, and initiating the display of the display content of the first window within the revised appearance shape of the first window.

5. The method of claim 1, wherein the step of revising the initial appearance shape of the first window into the revised appearance shape comprises removing a selected portion of the initial appearance of the first window to define a void within the revised appearance shape of the first window.

6. The method of claim 5, further comprising:
initiating a display of a second window within the void so that the first window and the second window do not overlap, wherein display content of the second window and the display content of the first window both remain active and displayed within the graphical user interface environment display regardless of different Z-order values of the first window and the second window.

7. The method of claim 5, wherein the display content of the initial appearance shape of first window has an initial size and is displayed at an initial content location relative to at least one boundary edge line of the first window; and
wherein the step of initiating the display of the display content of the first window within the revised appearance shape of the first window comprises initiating a display that omits portions of the display content that were displayed in the initial appearance of the first window within the removed selected portion.

8. The method of claim 5, wherein the display content of the initial appearance shape of first window has an initial size and is displayed at an initial content location relative to at least one boundary edge line of the first window; and
wherein the step of initiating the display of the display content of the first window within the revised appearance shape of the first window comprises initiating a display that presents the display content to fit within the revised appearance shape of the first window.

9. The method of claim 8, wherein the display content of the first window comprises text content, the initial size of the text content is a font size, and the initial content location is defined by a first window justification margin dimension relative to at least one boundary edge line of the first window; and
wherein the step of initiating the display of the text content of the first window within the revised appearance shape of the first window comprises initiating a display that rearranges the text content to fit an entirety of an amount of the text content that was presented in the initial appearance shape as a function of a revised justification margin dimension that is different from the first window justification margin dimension.

10. A system, comprising:
a processing unit in communication with a computer readable memory and a tangible computer-readable storage medium;
wherein the processing unit, when executing program instructions stored on the tangible computer-readable storage medium via the computer readable memory:
receives a selection of at least one boundary edge line of a first window that is displayed within a graphical user interface environment in an initial appearance shape and comprises display content;
removes the selected at least one boundary edge line of the first window;
receives a definition of at least one new replacement boundary element;
revises the initial appearance shape of the first window into a revised appearance shape that is defined by the at least one new replacement boundary element and at least one remainder boundary edge line that is not removed; and
initiates a display of the display content of the first window within the revised appearance shape of the first window.

11. The system of claim 10, wherein the processing unit, when executing the program instructions stored on the computer-readable storage medium via the computer readable memory, removes the at least one boundary edge line by erasing the at least one boundary edge line.

12. The system of claim 10, wherein the processing unit, when executing the program instructions stored on the computer-readable storage medium via the computer readable memory, receives the definition of the at least one new replacement boundary element by receiving at least one of a corner dot and a boundary line dash, wherein the received at least one of the corner dot and the boundary line dash indicates a position of at least one new boundary element that is different from a position of the removed selected at least one boundary edge line of the first window, and wherein the revised appearance shape of the first window has a revised footprint area that is different from an initial footprint of the first window.

13. The system of claim 10, wherein the processing unit, when executing the program instructions stored on the computer-readable storage medium via the computer readable memory, revises the initial appearance shape of the first window into the revised appearance shape by removing a selected portion of the initial appearance of the first window to define a void within the revised appearance shape of the first window.

14. The system of claim 13, wherein the processing unit, when executing the program instructions stored on the computer-readable storage medium via the computer readable memory:
initiates a display of a second window within the void so that the first window and the second window do not overlap; and
initiates an active display of content within the second window simultaneously with content actively displayed in the first window within the graphical user interface environment, wherein the first window and the second window both remain active and displayed within the graphical user interface environment display regardless of different Z-order values of the first window and the second window.

15. The system of claim 13, wherein the display content of the initial appearance shape of first window has an initial size and is displayed at an initial content location relative to at least one boundary edge line of the first window; and
wherein the processing unit, when executing the program instructions stored on the computer-readable storage medium via the computer readable memory, initiates a display of the display content of the first window within the revised appearance shape of the first window that presents the display content to fit within the revised appearance shape of the first window.

16. A computer program product for revising the shape of a window displayed in a graphical user interface environment, the computer program product comprising:
a computer readable tangible storage medium having computer readable program code embodied therewith, the computer readable program code comprising instructions that, when executed by a computer processing unit, cause the computer processing unit to:
receive a selection of at least one boundary edge line of a first window that is displayed within a graphical user interface environment in an initial appearance shape and comprises display content;
remove the selected at least one boundary edge line of the first window;
receive a definition of at least one new replacement boundary element;
revise the initial appearance shape of the first window into a revised appearance shape that is defined by the at least one new replacement boundary element and at least one remainder boundary edge line that is not removed; and
initiates a display of the display content of the first window within the revised appearance shape of the first window.

17. The computer program product of claim 16, wherein the computer readable program code instructions, when executed by the computer processing unit, further cause the computer processing unit to remove the at least one boundary edge line by erasing the at least one boundary edge line.

18. The computer program product of claim 16, wherein the computer readable program code instructions, when executed by the computer processing unit, further cause the computer processing unit to receive the definition of the at least one new replacement boundary element by receiving at least one of a corner dot and a boundary line dash, wherein the received at least one of the corner dot and the boundary line dash indicates a position of at least one new boundary element that is different from a position of the removed selected at least one boundary edge line of the first window, and wherein the revised appearance shape of the first window has a revised footprint area that is different from an initial footprint of the first window.

19. The computer program product of claim 16, wherein the computer readable program code instructions, when executed by the computer processing unit, further cause the computer processing unit to revise the initial appearance shape of the first window into the revised appearance shape by removing a selected portion of the initial appearance of the first window to define a void within the revised appearance shape of the first window.

20. The computer program product of claim 19, wherein the computer readable program code instructions, when executed by the computer processing unit, further cause the computer processing unit to:
initiates a display of a second window within the void so that the first window and the second window do not overlap; and
initiates an active display of content within the second window simultaneously with content actively displayed in the first window within the graphical user interface environment, wherein the first window and the second window both remain active and displayed within the graphical user interface environment display regardless of different Z-order values of the first window and the second window.
